(19) United States
(12) Patent Application Publication
(10) Pub. No.: US 2014/0279025 A1
(43) Pub. Date: Sep. 18, 2014

(54) METHODS AND APPARATUS FOR DISPLAY OF MOBILE ADVERTISING CONTENT

(71) Applicants: Matevz Klanjsek, Ljubljana (SI); Tadej Strok, Celje (SI)

(72) Inventors: Matevz Klanjsek, Ljubljana (SI); Tadej Strok, Celje (SI)

(73) Assignee: Celtra Inc., Cambridge, MA (US)

(21) Appl. No.: 13/828,626

(22) Filed: Mar. 14, 2013

(51) Int. Cl. G06Q 30/02

(52) U.S. Cl. CPC G06Q 30/0276
USPC 705/14.64

(57) ABSTRACT

Embodiments of the invention provide techniques that enable users to create mobile advertisements having any of several formats. In one format, one or more animated elements may be displayed as an ad transitions from one display state to another. In another format, one or more elements of the mobile advertisement may react to input by a viewer of the mobile advertisement. In yet another format, a viewer may cause a banner ad to expand by “sliding” an element in a given direction, and/or in accordance with a specified pattern.

### BACKGROUND

A mobile advertisement is one which is designed for display on a mobile device (e.g., a handheld device such as a “smartphone” or tablet computer, a dash-top device such as a GPS navigation device, a satellite radio receiver, a mobile payment platform, a content reproduction device such as an MP3 player, a video game console, or any other type of mobile device).

Mobile advertisements may take any of numerous forms. A “banner” advertisement (or to “banner ad”) is one representative type of vehicle for displaying advertising content. Generally, a banner ad is shown to a viewer within an environment that is defined by a publisher, such as a web page (in which case the banner ad may be displayed by a mobile browser executing on the mobile device), or a mobile application (in which case the banner ad may be displayed “in-app,” or by the mobile application, such as a game or other native application executed by the mobile device). Banner ads are often rectangular in shape, include advertising content (e.g., text, images, animation, etc.) within their borders, and are shown near the top edge or bottom edge of the viewable portion of the environment. With some banner ads, viewer input can cause the advertisement to expand to occupy a larger portion of the viewable area of the environment, and to display additional advertising content. These so-called “expandable banner ads” often allow a viewer to “click through” the advertising content to gain access to more information on the advertised goods or services.

### SUMMARY

Some embodiments of the invention provide techniques that enable users to create mobile advertisements suitable for display on mobile devices, such as mobile advertisements having any of several novel formats.

In one mobile advertisement format described herein, one or more elements may adorn an ad as it transitions from one display state to another. For example, in one example described below, one or more animated elements may be displayed as a banner ad appears to travel from outside the viewable portion of the display, to inside the viewable portion of the display, and/or as an expandable banner ad transitions from an un-expanded state to an expanded state. Any suitable element(s) may be displayed as the banner ad transitions from one such display state to another, including animated and non-animated elements. In some examples, the element(s) may borrow aesthetic and/or other qualities from the environment in which the banner ad is to be displayed. For example, if the environment in which the mobile advertisement is to be displayed is a game, then the element(s) may represent characters of the game, and/or incorporate other aesthetic or ornamental aspects of the game. If the elements represent characters, then they may move or act in a way that resembles how they move or act during game play. As another example, if the environment is a website, then the element(s) may incorporate elements of the site's “look and feel.” By employing one or more elements that borrow from the underlying environment's aesthetic qualities, embodiments of the invention may enable advertising content to be presented to a viewer in a manner which is unobtrusive, as the advertising content may “blend in” with the underlying environment to a certain extent, and yet is visually engaging.

In another mobile advertisement format described herein, one or more elements of a banner ad may react to viewer input. As an example, if the banner ad is displayed in a web page environment, then the element(s) may respond to viewer input to a browser application that displays the web page and the ad. The element(s) may respond to viewer input in any suitable fashion. For example, the element(s) may respond to a viewer scrolling the content of a web page by moving in a corresponding fashion. In one example described below, elements move from left to right across the banner ad when the viewer scrolls content up, and from right to left when the user scrolls the content down. Of course, the element(s) of a banner ad need not move in any particular direction, or otherwise respond to viewer input in any particular way, as the element(s) may respond in any suitable fashion. By incorporating elements into a banner ad that react to viewer input, embodiments of the invention may capture the user's attention by creating the illusion of user control over the elements, which may serve to direct the viewer's eye to the goods or services which are advertised.

In another mobile advertisement format described herein, a viewer may cause a banner ad to expand through continuous touch input to a touch screen interface which “slides” an element in a given direction, and/or in accordance with a specified pattern. By controlling the expansion of the banner ad so that it only occurs after the viewer slides the element, embodiments of the invention may prevent a viewer from mistakenly expanding a banner ad through an errant tap or click. In this respect, the inventors have appreciated that mistakenly causing a banner ad to expand may frustrate the viewer, since the expanded ad may obscure content that the viewer wishes to access until he/she contracts it, and that this frustration may extend to the goods or services which are advertised in the ad. As such, some embodiments of the invention may prevent viewer frustration and thus potential ill feelings toward advertised goods or services.

The foregoing is a non-limiting summary of the invention, some embodiments of which are defined by the attached claims.

### BRIEF DESCRIPTION OF DRAWINGS

The accompanying drawings are not intended to be drawn to scale. In the drawings, each identical or nearly identical component as illustrated in various figures is represented by a like numeral. For purposes of clarity, not every component may be labeled in every drawing. In the drawings:

FIGS. 1A-1C are depictions of a banner ad displayed on a screen interface, in which an animated element is displayed as the banner ad transitions from one display state to another, in accordance with some embodiments of the invention;

FIGS. 2A-2C are depictions of the banner ad of FIGS. 1A-1C being expanded, in accordance with some embodiments of the invention;

FIGS. 3A-3C are depictions of a banner ad displayed on a screen interface, in which animated elements are displayed as the banner ad transitions from one display state to another, in accordance with some embodiments of the invention;

FIGS. 4A-4C are depictions of the banner ad of FIGS. 3A-3C being expanded, in accordance with some embodiments of the invention;

FIGS. 5A-5C are depictions of a banner ad displayed on a screen interface, in which animated elements are displayed as the banner ad transitions from one display state to another, in accordance with some embodiments of the invention;

FIGS. 6A-6F are depictions of the banner ad of FIGS. 5A-5C being expanded, in accordance with some embodiments of the invention;

FIG. 7 is a flowchart of a representative process for facilitating creation of a mobile advertisement, in accordance with some embodiments of the invention;

FIGS. 8A-8C are depictions of a mobile device screen interface showing a banner ad which includes one or more elements that react to viewer input, in accordance with some embodiments of the invention;

FIGS. 9A-9C are depictions of a mobile device screen interface showing a banner ad which includes one or more elements that react to viewer input, in accordance with some embodiments of the invention;

FIG. 10 is a flowchart of a representative process for facilitating creation of a mobile advertisement, in accordance with some embodiments of the invention;

FIGS. 11A-11F are depictions of a mobile device screen interface showing a banner ad which includes an element that a viewer slides to expand the banner ad, in accordance with some embodiments of the invention;

FIGS. 12A-12F are depictions of a mobile device screen interface showing a banner ad which includes an element that a viewer slides to expand the banner ad, in accordance with some embodiments of the invention;

FIGS. 13A-13F are depictions of a mobile device screen interface showing a banner ad which includes an element that a viewer slides to expand the banner ad, in accordance with some embodiments of the invention;

FIG. 14 is a flowchart of a representative process for facilitating creation of a mobile advertisement, in accordance with some embodiments of the invention; and

FIG. 15 is a block diagram of a representative computing device which may be used to implement aspects of the invention.

### DETAILED DESCRIPTION

Some embodiments of the invention enable users to create a mobile advertisement having any of several novel formats. In one format, one or more elements may adorn, or otherwise be displayed, as the ad transitions from one display state to another, such as when a banner ad appears to travel from outside the viewable portion of the environment in which the banner ad is displayed to inside the viewable portion, or when an expandable banner ad is changed from an un-expanded state to an expanded state. The element(s) may, for example, be animated, and may borrow aesthetic and/or other qualities from the environment in which the ad is to be displayed.

One example sequence showing animated elements that are displayed as a banner ad is brought into view within an environment (specifically, a game environment) is shown in FIGS. 1A-1C. In this example, the game that is played in the environment includes characters, element 108 represents one of the characters, and is shown as the banner ad is brought into view. In this respect, in FIG. 1A, the left edge 105 of the banner ad 101 appears at the right edge 110 of the viewable portion, as the banner ad appears to move in a right-to-left direction. FIG. 1B shows banner ad 101 approaching the center of the top 102 of the viewable portion, with element 108 having moved closer to the middle of the banner ad's interior. FIG. 1C shows banner ad 101 having arrived at the location at which it will sit stationary, centered near the top 102 of the viewable portion, with the advertising content (in the example shown, “banner unit”) being displayed to the viewer. It should be appreciated that although advertising content is not shown to the viewer in the example of FIGS. 1A-1C until the banner ad reaches the location at which it will sit stationary, embodiments of the invention are not limited to such an implementation, as content may be shown at any suitable point during the ad's display.

FIGS. 2A-2C show an example sequence which illustrates that animated elements may be shown not only as a banner ad is brought into view, but also as an expandable banner ad is expanded. In FIG. 2A, the left and right edges of the expandable banner ad 101 expands toward the left and right edges 104 and 110, respectively, of the viewable portion. In FIG. 2B, the lower edge 106 of the ad expands toward the lower edge 107 of the viewable portion to expand the overall area encompassed by the ad. In this example, the area within the ad's edges is split into four separate components, and gaps between the components provide a “view” beyond to the underlying environment, so that the user perceives the ad as being integrated with the environment. FIG. 2C shows the ad in a fully expanded state, with the four separate portions being joined to display advertising content (in the example shown, “expanded unit”). In this example, animated elements 201, 202 and 203 at the periphery of ad 101 resemble element 108, described above, and are designed to visually engage the viewer while creating the perception that the ad forms part of the underlying environment.

FIGS. 3A-3C show another example of the types of animated elements that may be shown as a banner ad is brought into view. In this example, the underlying environment is a game in which birds fly during game play, and the elements represent game characters. In FIG. 3A, elements 305, 310 and 315, each representing a different game character, appear to be in flight and dragging the banner ad in a right-to-left direction from right edge 302 of the viewable portion of the display toward the top center. FIG. 3B shows the banner ad as it approaches the top center, with elements 420 and 425, also representing game characters, having come into view. FIG. 3C shows the banner ad having arrived at the top center of the viewable portion, causing advertising content (in the example shown, “banner unit) to be displayed to the viewer of the ad.

FIGS. 4A-4C show an expandable version of the banner ad described in FIGS. 3A-3C being expanded to display additional advertising content. The sequence depicted in FIGS. 4A-4C may be shown, for example, when a viewer provides input (e.g., a click, tap, etc.) to the area encompassed by the edges of ad 301. In the example shown, elements 305-325 appear to “stretch” the ad until it occupies nearly all of the viewable portion of the environment. Specifically, animated elements 305 and 315 appear to be pulling the edges of the ad toward the top left and bottom left of the screen, respectively, and elements 520 and 525 appear to be pulling the ad toward the top right and bottom right edges of the screen, respectively. FIG. 4B shows the ad having been “stretched” to occupy much of the viewable portion, and FIG. 4C shows the expanded ad in its final position, with advertising content being displayed (i.e., in the example shown, “expanded unit”).

FIGS. 5A-5C show yet another example of the types of elements which may be shown as a banner ad is brought into view. The example shown relates to a game in which a player may use a “light saber.” In FIG. 5A, animated handle element 505 appears from “behind” the top of right edge 510 of the viewable portion of the display, and light saber 515 extends from handle element 505. FIG. 5B shows the light saber element 515 being fully extended from handle element 505, and handle element 505 having moved away from the top edge 501 of the viewable portion of the display toward the bottom edge. This causes area 520, in which advertising content will be displayed, to become apparent to the viewer. FIG. 5C shows the banner ad being displayed near the top center of the display, with advertising content (in the example shown, “banner unit”) being shown to the viewer.

FIGS. 6A-6F show an expandable version of the banner ad of FIGS. 5A-5C being expanded. In FIG. 6A, two handle elements 605 and 610 appear near the top right and bottom left corners of the display, respectively. In FIG. 6B, a light saber element extends from each of handle elements 605 and 610, along the top and bottom of the display screen, with light saber element 615 extending in a right-to-left direction from handle element 605, and light saber element 620 extending in a left-to-right direction from handle element 610. FIG. 6C shows light saber element 615 having rotated in a counter-clockwise direction about axis 625, and light saber element 620 having rotated in a clockwise direction about axis 630, so that the light saber elements appear to intersect and reveal an area 635 in which advertising content will be shown. FIGS. 6D and 6E, area 635 appears to expand to occupy much of the display, and FIG. 6F shows area 635 showing advertising content (i.e., in the example shown, “expanded unit”).

It can be seen from the examples described above that by causing one or more elements to adorn an ad or otherwise be displayed as the ad comes into view and/or expands, some embodiments of the invention may present advertising content in a manner which is visually engaging. Further, by using elements that borrow from the aesthetic and/or other qualities of the underlying environment, some embodiments of the invention may allow advertising content to be displayed in an unobtrusive manner, so that ad content may blend in with the underlying environment to some extent rather than seeming incongruous, and yet be visually appealing to the viewer.

FIG. 7 is a flow chart of a representative process 700 for facilitating creation of an ad having the qualities described above. At the start of process 700, one or more tools are provided in act 710 which enable a user to define a manner in which an ad is to transition from one display state to another, and one or more animated elements which are to be displayed as the transition occurs. This may be performed in any of numerous ways, using any of numerous tools. In one example, a user may employ the content development and management platform is described in co-pending U.S. patent application Ser. No. 13/464,107, entitled “RICH MEDIA MOBILE ADVERTISING DEVELOPMENT PLATFORM”, filed on May 4, 2012, the entirety of which is incorporated herein by reference. The platform may provide a graphical interface which allows the user to define various aspects of the ad, such as a manner in which the ad transitions from one display state to another, and the element(s) which are to be shown as transition occurs.

Definition of these and other aspects of the banner ad may be performed in any suitable fashion. In one example, a user may construct advertising creative from one or more semantically connected “ad units” which, once finalized, represent the banner ad. For example, the user may construct creative for a single unit for a banner ad, construct creative for plural ad units for an expandable banner ad, etc. The user may define a logical connection between units, such as the manner in which the ad is to appear on the display, or the replacement of one unit with another when viewer input is received. The user may then select “decoration” to adorn one or more of the ad units, such as one or more animated elements, or non-animated elements, to be shown during the ad's display. This may involve, for example, selecting the element(s) from a repository of previously created assets, and defining the manner in which the element(s) are to be shown to the viewer as the ad transitions from one ad unit to another. The user may then assemble the ad by “merging” the ad units and the decoration, which may be performed in any suitable fashion, and may depend in part on the nature of the decoration defined by the user. The completed ad may then be served into the publisher environment.

At the completion of act 710, process 700 completes.

It should be appreciated that although some of the specific examples described above relate to a banner ad, embodiments of the invention are not limited to enabling the creation of banner ads. For example, the techniques and/or tools described herein may be used to create expandable banner ads, interstitial ads, and/or any other suitable type(s) of ad, in any suitable format(s). Further, embodiments of the invention are not limited to enabling the creation of ads which include animated elements that are shown as the ad transitions from one display state to another. Any suitable type of element, having any suitable characteristics, may be used.

As noted above, some embodiments of the invention provide techniques for creating mobile advertisements which include one or more elements that react to viewer input. For example, if the mobile advertisement is to be displayed in a web page, then the element(s) may react to viewer input to a browser application which causes the web page to be displayed.

An example of this type of mobile advertisement is shown in FIGS. 8A-8C. These figures depict a mobile device 800 which executes a mobile browser displaying a web page 801. Of course, it should be appreciated that embodiments of the invention are not limited to being used with devices that execute a mobile browser. For example, this type of mobile advertisement may be displayed in a game environment, by a game console or other type of device that does not execute a mobile browser. If a mobile browser is employed, any suitable browser may be used, as embodiments of the invention are not limited in this respect.

FIG. 8A shows a banner ad 805 shown near the bottom of a viewable area 802 defined by the browser. Content comprising web page 801 occupies the remainder of viewable area 802. The banner ad includes element 812, which in this example is an image of the head of a razor, near the left edge of the ad.

In FIG. 8B, input provided to the mobile browser to scroll the content shown in viewable area 802 causes element 810 to shift position, to bring into view the razor's shaft, and to align the razor's blade with the left edge of the ad. In FIG. 8C, continued input to scroll the content shown in viewable area 802 causes element 812 to move away from the left edge of the ad and toward the right edge, so that the element 812 reacts to the viewer's input. Thus, in accordance with some embodiments of the invention, an element within an ad reacts to input that is external to the ad. In this example, that input is supplied by the viewer to a browser. However, it should be appreciated that input supplied to any facility external to an ad may cause an ad element to react. For example, input supplied to a game application may cause an element of an ad displayed in the game to react. Embodiments of the invention are not limited to any particular mode of implementation.

It should also be appreciated that an ad element may react to any suitable type of input. For example, embodiments of the invention are not limited to an ad element responding to a viewer's scroll operation, as any suitable form of viewer input may elicit a response from an ad element.

Some embodiments of the invention may provide for modifying the manner in which element 812 moves with different input. Using the example shown to illustrate, some embodiments may provide for element 812 to move in a right-to-left direction if the user scrolls down, which may cause any ad content that was previously revealed to become obscured. Thus, in these embodiments, the viewer of the ad content may be provided with control over the element's placement and movement, enabling the user to control how much of the advertising content is shown on the display.

Another example ad having elements that react to user input is shown in FIGS. 9A-9C. In this example, user input to a mobile browser does not influence the amount of advertising content that is shown (it can be seen in FIGS. 9A-9C that the advertising content “banner unit” is fully displayed), but rather causes an element to react in other ways. Specifically, FIG. 9A shows banner ad 905, which includes element 910, representing a propeller. In FIG. 9B, it can be seen that as the user provides input to the browser to scroll the web page content shown in viewable area 902, the propeller element begins to spin in a clockwise direction, and in FIG. 9C this motion continues. User input may affect element motion in any of several ways. In one example, continuing to scroll web page content up may cause the propeller to continue to spin, faster scrolling may cause the propeller to spin faster, or scrolling web page content down may cause the propeller to spin in the opposite direction.

It should be appreciated that by presenting elements that react to input, some embodiments of the invention may present advertising content in a manner which captures the user's attention, which may make him/her more likely to want to access additional information about advertised goods or services.

FIG. 10 is a flow chart of a representative process 1000 for facilitating creation of a banner ad with one or more elements that react to viewer input. At the start of process 1000, one or more tools are provided which enable a user to define a reaction by one or more ad elements to specified viewer input. As with representative process 700, described above in relation to FIG. 7, this may be performed in any of numerous ways, using any of numerous types of tools, including the content development and management platform described in the above-cited co-pending application. The platform may provide an interface that allows the user to define various aspects of the ad, such as the element(s) of the ad that reacts to user input, and the form(s) of input to which the element(s) react(s).

In one example, a user may select a publisher environment into which the ad will be served, and then specify one or more quantities describing an ad viewer's interaction with the environment in which the ad is displayed. For example, a quantity may characterize a scrolling, zooming or other operation which the viewer may perform during the ad's display. The user may select one or more elements included in the ad, and one or more quantities associated with each element. The quantities may define the element's size, position within the ad, opacity, rotation speed, and/or other characteristics. The user may then define a setting (e.g., select from a predetermined selection of settings, define a new setting, etc.) which describes a relationship between the quantity or quantities describing the ad viewer's input to the environment, and the quantity of quantities associated with each element. For example, a setting may specify that viewer input having certain characteristics (defined by the associated quantity or quantities) is to cause an element to change position (e.g., move in a straight line, travel along a curve, etc.) change size (e.g., expand, contract, etc.) change opacity (e.g., become transparent), rotate, begin an animated sequence, and/or respond in any other suitable way. The ad may then be served into the publisher environment. During the ad's display, viewer input may be monitored to determine whether the quantity associated with viewer input is satisfied (as an example, whether scrolling in a specified direction and/or at a specific speed is initiated), and if so, may calculate a new quantity or quantities for the element(s), based on the setting.

At the completion of act 1010, process 1000 completes.

As noted above, some embodiments of the invention allow a user to create a mobile advertisement which includes one or more elements that cause a banner ad to expand in response to a viewer's input to “slide” the element(s) in a specified direction and/or according to a specified pattern. An example display sequence of a mobile advertisement which includes such elements is shown in FIGS. 11A-11F, which show a mobile device 1100 executing a mobile browser displaying a web page 1101. As noted above, although an environment which employs a mobile browser is used in this example, embodiments of the invention are not limited to being used with a mobile browser. If a mobile browser is used, then any suitable mobile browser may be employed, as embodiments of the invention are not limited in this respect.

In FIG. 11A, a banner ad 1101 is shown near the bottom of a display area 1102 presented by the mobile browser. The banner ad includes an element 1105 representing a button showing the text “slide to expand,” indicating to the user that he/she may expand the banner ad by sliding the button in a left-to-right direction. FIG. 11B shows the user having provided continuous touch input to element 1105 to slide the element away from the left-hand edge of the banner ad and toward the right-hand edge. FIG. 11C shows element 1105 having been slid all the way across the banner edge to its right edge, which in this example causes the banner ad to be expanded to show additional advertising content. This expansion is shown in FIGS. 11D-11F. In FIG. 11D, the right-hand edge of the expanded ad 1110 moves in a left-to-right direction toward the right edge of display area 1102, and banner ad 1101 disappears under the lower edge of display area 1102. In FIGS. 11E-11F, continued movement of the right-hand edge of expanded ad 1110 toward the right edge of display area 1102 gradually obscures web page 1101, until the expanded ad 1110 occupies the entirety of display area 1102.

Another example is shown in FIGS. 12A-12F. In FIG. 12A, banner ad 1201 is shown near the bottom edge of display area 1202, and includes element 1205, representing a button, which indicates via the text “slide to expand” that the ad may be expanded by sliding the button in a left-to-right direction. Banner ad 1201 includes advertising content 1215A (i.e., in the example shown, “creative A”). FIG. 12B shows the user having provided continuous touch input to slide element 1205 toward the right edge of banner ad 1201. In this example, this input causes different advertising content 1215B (i.e., in the example shown, “creative B”) to be revealed. Thus, using this format, more advertising content than is conventionally included in banner ads may be displayed. It can be seen that when element 1205 reaches the right edge of banner ad 1201, only advertising content 1215B is shown, as advertising content 1215A has become obscured. In this example, element 1205 reaching the right edge of banner ad 1201 causes the banner ad to expand, in much the same way as is described above in relation to FIGS. 11D-11F. Specifically, in FIG. 12D, the right-hand edge of the expanded ad 1210 moves in a left-to-right direction toward the right edge of display area 1202, and banner ad 1201 disappears under the lower edge of display area 1202. In FIGS. 12E-12F, continued movement of the right-hand edge of expanded ad 1210 toward the right edge of display area 1202 gradually obscures web page 1201, until the expanded ad 1210 occupies the entirety of display area 1202.

FIGS. 13A-13F show another example wherein continuous touch input to an element included in a banner ad causes additional advertising content to be revealed in the banner ad. However, in this example, the additional content appears to be “attached” to the element, and moves in unison with the element as it slides from one edge to the other.

In FIG. 13A, banner ad 1301 is shown near the bottom edge of display area 1302, and includes element 1305, representing a button, which indicates via the text “slide to expand” that the ad may be expanded by sliding the button in a left-to-right direction. Banner ad 1301 includes advertising content 1315A (i.e., in the example shown, “creative A”). FIG. 13B shows the user having slid element 1305 toward the right edge of banner ad 1301, causing different advertising content 1315B (i.e., in the example shown, “creative B”) to be shown. In this example, advertising content 1315B is centered within the area to the left of element 1305 within banner ad 1301. When element 1305 reaches the right edge of banner ad 1301, only advertising content 1315B is shown (as advertising content 1315A has become obscured), and advertising content 1315B is centered within the banner ad's display area.

FIGS. 13D-13F show that when element 1205 reaches the right edge of banner ad 1301, the banner ad expands to display further advertising content. Specifically, in FIG. 13D, the right-hand edge of expanded ad 1310 moves in a left-to-right direction toward the right edge of display area 1302, and banner ad 1301 gradually disappears under the lower edge of display area 1302, until expanded ad 1310 occupies the entirety of display area 1302 in FIG. 13F.

It should be appreciated that by requiring continuous touch input to expand a banner ad, some embodiments of the invention may reduce the possibility of a user accidentally touching, tapping of clicking a banner ad and causing it to expand to obscure the content the user actually wishes to view. In this respect, the inventors have appreciated that a user's frustration with an ad that expands despite the user's wishes may cause the user to become frustrated with not only the ad, but also the goods or services described in the ad.

FIG. 14 is a flow chart of a representative process 1400 for facilitating creation of a banner ad with an element that expands upon user input being received which slides an element of the ad. At the start representative process 1400, one or more tools are provided in act 1410 which enable a user to specify the input which a viewer is to provide to cause the ad to expand. As with representative processes 700 (FIG. 7) and 1000 (FIG. 10) described above, this may be performed in any of numerous ways, such as by providing a content development and management platform like that which is described in the above-cited co-pending application. The platform may provide an interface that allows the user to specify the viewer input that is to cause the ad to expand. For example, the user may specify that the ad is to expand upon the viewer sliding a button in a straight line from one edge of the ad to another, upon the viewer sliding the button in a predefined geometric pattern (e.g., along a line, along a curve, to form a polygon, to form a circle, etc.). Any of numerous types of viewer input may be specified.

At the completion of act 1410, process 1400 completes.

It should be appreciated that any or all of the representative ad formats described above may be used in any suitable environment. For example, a banner ad that may be expanded upon a user sliding a button need not be displayed in a web page environment, and may instead be shown in a game environment, or any other suitable environment(s).

It should also be appreciated that any two or more of the ad formats described above may be combined in a single mobile advertisement. For example, a mobile advertisement may include one or more animated elements that are shown as the ad is brought into view, and the ad may include a button which the viewer is to slide to cause the ad to expand, and/or may include an element which reacts to viewer input in some fashion.

It should further be appreciated that although much of the description given above relates to banner ads, not all embodiments of the invention are so limited. For example, any or all of the techniques described above may be used in creating expandable banner ads, or ads which do not include banners, such as interstitial ads, and/or mobile advertisements of other types.

FIG. 15 illustrates one example of a suitable computing system environment 1500 which may be used to implement aspects of the invention. The computing system environment 1500 is only one example of a suitable computing environment, and is not intended to suggest any limitation as to the scope of use or functionality of the invention. Neither should the computing environment 1500 be interpreted as having any dependency or requirement relating to any one or combination of components illustrated in the exemplary operating environment 1500. In this respect, the invention is operational with numerous other general purpose or special purpose computing system environments or configurations. Examples of computing systems, environments, and/or configurations that may be suitable for use with the invention include, but are not limited to, mobile devices (e.g., smartphones, tablet devices, cellular telephones, game consoles, dash-top devices such as GPS navigation devices, satellite radio receivers, mobile payment platforms, content reproduction devices such as MP3 players, and/or other types of mobile devices), personal computers, server computers, laptop computers, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

FIG. 15 depicts a general purpose computing device in the form of a computer 1510. Components of computer 1510 may include, but are not limited to, a processing unit 1520, a system memory 1530, and a system bus 1521 that couples various system components including the system memory to the processing unit 1520. The system bus 1521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1510 typically includes a variety of computer readable media. Computer readable media can be any available media that can be accessed by computer 1510 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other one or more media which may be used to store the desired information and may be accessed by computer 1510. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer readable media.

The system memory 1530 includes computer storage media in the form of volatile and/or nonvolatile memory such as read only memory (ROM) 1531 and random access memory (RAM) 1532. A basic input/output system 1533 (BIOS), containing the basic routines that help to transfer information between elements within computer 1510, such as during start-up, is typically stored in ROM 1531. RAM 1532 typically contains data and/or program modules that are immediately accessible to and/or presently being operated on by processing unit 1520. By way of example, and not limitation, FIG. 15 illustrates operating system 1534, application programs 1535, other program modules 1536, and program data 1537.

The computer 1510 may also include other removable/non-removable, volatile/nonvolatile computer storage media. By way of example only, FIG. 15 illustrates a hard disk drive 1541 that reads from or writes to non-removable, nonvolatile magnetic media, a magnetic disk drive 1551 that reads from or writes to a removable, nonvolatile magnetic disk 1552, and an optical disk drive 1555 that reads from or writes to a removable, nonvolatile optical disk 1556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1541 is typically connected to the system bus 1521 through an non-removable memory interface such as interface 1540, and magnetic disk drive 1551 and optical disk drive 1555 are typically connected to the system bus 1521 by a removable memory interface, such as interface 1550.

The drives and their associated computer storage media discussed above and illustrated in FIG. 15, provide storage of computer readable instructions, data structures, program modules and other data for the computer 1510. In FIG. 15, for example, hard disk drive 1541 is illustrated as storing operating system 1544, application programs 1545, other program modules 1546, and program data 1547. Note that these components can either be the same as or different from operating system 1534, application programs 1535, other program modules 536, and program data 1537. Operating system 1544, application programs 1545, other program modules 1546, and program data 1547 are given different numbers here to illustrate that, at a minimum, they are different copies. A user may enter commands and information into the computer 1510 through input devices such as a keyboard 1562 and pointing device 1561, commonly referred to as a mouse, trackball or touch pad. Other input devices (not shown) may include a microphone, joystick, game pad, satellite dish, scanner, or the like. These and other input devices are often connected to the processing unit 1520 through a user input interface 560 that is coupled to the system bus, but may be connected by other interface and bus structures, such as a parallel port, game port or a universal serial bus (USB). A monitor 1591 or other type of display device is also connected to the system bus 1521 via an interface, such as a video interface 1590. In addition to the monitor, computers may also include other peripheral output devices such as speakers 1597 and printer 1596, which may be connected through a output peripheral interface 1595.

The computer 1510 may operate in a networked environment using logical connections to one or more remote computers, such as a remote computer 1580. The remote computer 1580 may be a personal computer, a server, a router, a network PC, a peer device or other common network node, and typically includes many or all of the elements described above relative to the computer 1510, although only a memory storage device 1581 has been illustrated in FIG. 15. The logical connections depicted in FIG. 15 include a local area network (LAN) 1571 and a wide area network (WAN) 1573, but may also include other networks. Such networking environments are commonplace in offices, enterprise-wide computer networks, intranets and the Internet.

When used in a LAN networking environment, the computer 1510 is connected to the LAN 1571 through a network interface or adapter 1570. When used in a WAN networking environment, the computer 1510 typically includes a modem 1572 or other means for establishing communications over the WAN 1573, such as the Internet. The modem 1572, which may be internal or external, may be connected to the system bus 1521 via the user input interface 1560, or other appropriate mechanism. In a networked environment, program modules depicted relative to the computer 1510, or portions thereof, may be stored in the remote memory storage device. By way of example, and not limitation, FIG. 15 illustrates remote application programs 1585 as residing on memory device 1581. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. At least one storage device having instructions encoded thereon which, when executed, perform a method of facilitating creation of a mobile banner advertisement, the method comprising acts of:
(A) receiving input from a user defining a manner in which a mobile advertisement is to transition from a first display state to a second display state; and
(B) receiving input from the user defining one or more elements of the mobile advertisement which are to be displayed as the transition from the first display state to the second display state occurs.

2. The at least one storage device of claim 1, wherein in the first display state the mobile advertisement is outside the viewable display area, and in the second display state the mobile advertisement is within the viewable display area.

3. The at least one storage device of claim 1, wherein in the first display state the mobile advertisement is unexpanded, and in the second display state the mobile advertisement is expanded.

4. The at least one storage device of claim 1, wherein the act (B) comprises receiving input defining one or more animated elements which are to be displayed at a periphery of the mobile advertisement.

5. The at least one storage device of claim 1, wherein the act (A) comprises receiving input defining one or more semantically connected ad units, and the act (B) comprises receiving input defining one or more elements to be shown during display of the semantically connected ad units.

6. The at least one storage device of claim 1, wherein the method is performed by a mobile advertisement content development and management platform.

7. A method for facilitating creation of a mobile advertisement, the method comprising acts of:
(A) receiving input from a user specifying an element of the advertisement;
(B) receiving input identifying an input operation to be performed by a viewer of the mobile advertisement during display of the mobile advertisement;
(C) receiving input specifying a manner in which the element is to respond to the input operation identified in the act (B).

8. The method of claim 7, wherein the act (B) comprises receiving input identifying a scroll operation or a zoom operation.

9. The method of claim 7, wherein the act (C) comprises receiving input specifying a change to one or more of the element's size, position, opacity or rotation speed.

10. The method of claim 9, wherein the act (C) comprises receiving input specifying a change to the element's position, and wherein the input specifies that the element is to move in a line.

11. The method of claim 7, wherein the act (A) comprises receiving input defining a quantity associated with the element, the act (B) comprises receiving input defining a quantity associated with the input operation, and the act (C) comprises receiving input defining a relationship between the quantity associated with the input operation and the quantity associated with the element.

12. The method of claim 7, further comprising an act of:
(D) receiving input identifying advertising content to be displayed within the mobile advertisement upon the element responding to the input operation.

13. The method of claim 7, wherein the acts (A), (B) and (C) are performed by a mobile advertisement content development and management platform.

14. A computer system for facilitating creation of a mobile advertisement, the mobile advertisement comprising an element, the computer system comprising:
at least one processor programmed to:
receive input from a user specifying a property of the element which allows a viewer of the advertisement to slide the element;
receive input from the user specifying that, in response to a viewer of the mobile advertisement sliding the element, the mobile advertisement is to expand.

15. The method of claim 14, wherein the at least one processor is programmed to receive input specifying a manner in which the viewer of the mobile advertisement is to slide the element to cause the mobile advertisement to expand.

16. The method of claim 15, wherein the input specifies that the viewer of the mobile advertisement is to slide the element in a geometric pattern.

17. The method of claim 16, wherein the geometric pattern comprises a line.

18. The method of claim 16, wherein the geometric pattern comprises a curve.

19. The method of claim 16, wherein the geometric pattern comprises a polygon.

20. The method of claim 15, wherein the input specifies that the viewer of the mobile advertisement is to slide the element from a first edge of the mobile advertisement to a second edge of the mobile advertisement.
